(19) United States
(12) Patent Application Publication
(10) Pub. No.: US 2005/0141352 A1
(43) Pub. Date: Jun. 30, 2005

(54) Method of adjusting the track to photo ratio in an optical disc drive

(75) Inventors: Hsiang-Yi Fu, Taipei (TW); Fu-Hsiang Chen, Taipei (TW); Ren-Te Lin, Taipei (TW); Tun-Chieh Lee, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/022,856

(22) Filed: Dec. 28, 2004

(30) Foreign Application Priority Data
Dec. 29, 2003 (TW) 92137350

(51) Int. Cl. G11B 7/085

(52) U.S. Cl. 369/30.1

(57) ABSTRACT

The present invention discloses a method of improving seeking precision by adjusting the track to photo ratio in an optical disc drive. After a disk is tray in, the number of photos detected by the optical disk drive is pre-calculated when the optical pickup module is to seek a predetermined number of tracks. The actual number of seeking tracks performed by the optical pickup module is calculated after the optical disk drive has detected the pre-calculated number of photos. Thereafter an optimal track to photo ratio is obtained.

This application claims the benefit of Taiwan application Serial No. 92137350, filed Dec. 29, 2003, the subject matter of which is incorporated herein by reference.

### BACKGROUND OF THE INVENTION

1. Field of the Invention

The invention relates in general to a method of precise seeking, and more particularly to a method of precise seeking by calibrating the track to photo ratio of an optical disc drive adopting a direct current motor.

2. Description of the Related Art

Normally, when an optical disc drive receives a read/write command outputted from the host, the seeking servo performs seeking first, i.e., use the sled motor of the optical disc drive to carry the pickup module to move to the target track indicated by the servo system. After having confirmed that the pickup head has reached the target track (i.e., on track), the optical disc drive accesses the disc. When the optical disc drive performs seeking and accessing, the speed of the movement of the pickup module will affect the read/write speed of the optical disc drive.

During the process of seeking (particularly during a long seek), the optical disc drive uses a photo signal to assist in calculating the number of the tracks of seeking. The generation and physical significance of the photo signal are explained below.

Referring to FIG. 1, a photo interrupt is shown. The movement of the sled driven by the sled motor causes the photo interrupt 13 rotating in direction 15. A constant light source is projected onto the position 21 such that the photo signal would have a pulse, or called as a photo, if the transparent portion 17 of the photo interrupt 13 passes through the position 21. To the contrary, the photo signal would not have a pulse if the non-transparent portion 19 of the photo interrupt 13 passes through the position 21. Since the intervals between transparent portions of the photo interrupt are fixed, within the interval of each pulse (photo) of the photo signal, the seeking distance of the sled is fixed as shown in FIG. 1 (i.e., the track to photo ratio is a constant).

Therefore, when the host issues a command of seeking 4,000 tracks, the pickup module does move 4,000 tracks when the optical disc drive detects 80 photos of the photo signal. (assuming that the track to photo ratio is 50:1) Thus the number of tracks of the long seeking performed by the pickup module can be easily calculated.

However, due to the variation of the manufacturing process of an optical disc, the optical disc drive cannot precisely move the pickup module to the target track.

Referring to FIG. 2, the specification of an optical disc is 1.6 μm per track pitch. If the variation in the manufacturing process of an optical disc causes the track pitch of an optical disc to become 1.7 μm. The distance (from the point A to C) of 10000 tracks of the optical disk with the process variation is quite different from the distance (the point A to B) of 10000 tracks of the standard optical disk, as shown in FIG. 2. Normally, the ratio of the number of tracks that the pickup module of an optical disc drive has moved to the photo number of the photo signal is 50:1 (i.e., a constant ratio). When receiving the command of seeking 10,000 tracks issued from the host, the optical disc drive will normally drive the sled motor to carry the pickup module until 200 photos appear. Under normal circumstances, the pickup module should have moved 10,000 tracks and reached the target track (200 times×50 tracks/time). However, due to track pitch variation of the optical disc, when the 200 photos appear, the pickup module is only carried to move 9,400 tracks, which are still 600 tracks away from the target track.

The above circumstance is disadvantageous when performing tracking after seeking, i.e., tracking will require a longer time and have a higher failure rate. Therefore, the optical disc drive needs a method of improving seeking precision, so that the pickup module can correctly reach the target track after seeking regardless of the track pitch variation.

### SUMMARY OF THE INVENTION

It is therefore an object of the invention to provide an optical disc drive for improving seeking precision, so as to resolve the failure of precise seeking of optical disc drive due to the variation in the manufacturing process of an optical disc.

The invention achieves the above-identified object by providing a method of improving seeking precision in an optical disc drive. Calculate the predetermined number of photos that should be detected by the optical disc drive when the pickup module moves by a predetermined number of tracks. Thereafter the actual number of tracks that the pickup module has moved when the optical disc drive detects the predetermined number of photos is calculated, so that the optimum track to photo ratio can be obtained.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a photo interrupt and a photo signal;

FIG. 2 is a diagram of track pitch errors caused by variation in the manufacturing process of an optical disc; and

FIG. 3 is a flowchart of a method of improving seeking precision according to the invention.

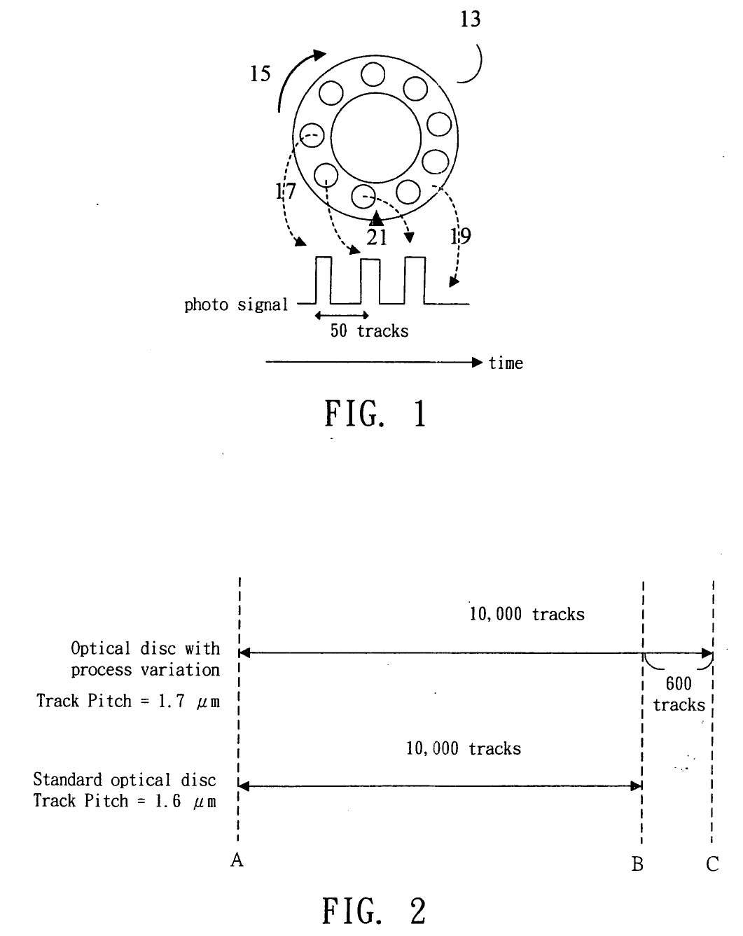

### DETAILED DESCRIPTION OF THE INVENTION

The variation in the manufacturing process of optical disc results in an uneven track pitch among optical discs, so that the sled motor cannot drive the pickup module to correctly reach the target track when the optical disc drive is seeking. This is advantageous to perform tracking after seeking, i.e., the tracking requires a longer time or even fails. Consequently, the optical disc drive spends a lot of time for accessing data. To overcome the above problem, the invention provides a method of adjusting the track to photo ratio in an optical disc drive.

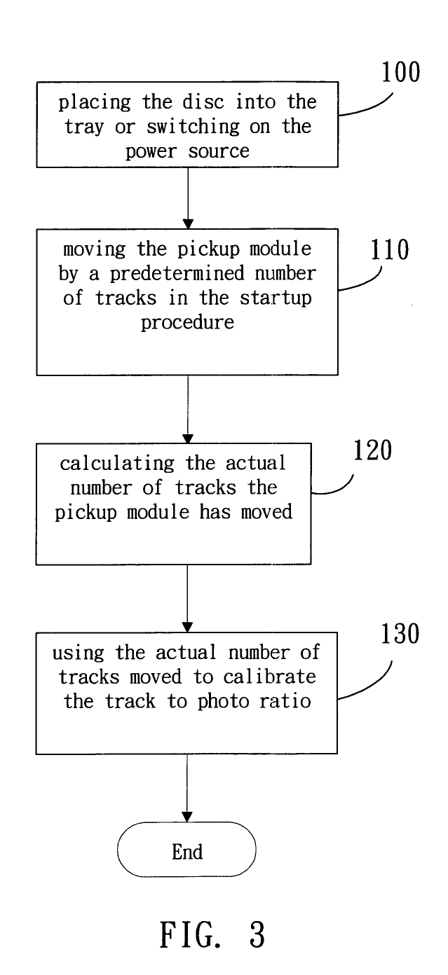

Referring to FIG. 3, a flowchart of a method of improving seeking precision is disclosed below:

step 100: placing the disc into the tray or switching on the power source of the optical disc drive;

step 110: moving the pickup module by a predetermined number of tracks in the startup procedure;

step 120: calculating the actual number of tracks the pickup module has moved;

step 130: using the actual number of tracks moved to calibrate the track to photo ratio.

When the disc is tray in or the power is on, the optical disc drive normally performs some startup procedures, during which the optical disc drive initializes system parameters so as to obtain the information of the optical disc to be accessed. The invention introduces the procedures of a method of improving seeking precision at the startup procedures.

First of all, move the pickup module by a predetermined number of tracks (assuming that the predetermined number of tracks is 10,000 tracks), furthermore, the initial track to photo ratio of the optical disc drive is 50:1. Therefore, under the initial track to photo ratio, the optical disc drive should have detected 200 pulses of the photo signal (i.e., the number of photos is 200).

Afterwards, the seeking process is completed (i.e., seeking 10,000 tracks) when the photo signal of the optical disc drive generates 200 photos. Meanwhile, the actual number of tracks of seeking can be obtained by detecting the time position of the optical disc. It can be inferred that the actual track pitch of the optical disc is longer than a standard one, if the actual number of tracks of seeking amounts to 9,000 tracks only. Therefore, the track to photo ratio of the optical disc drive needs to be adjusted to improve the seeking precision of the optical disc drive. The calibrated track to photo ratio of 45:1 can be obtained by having the actual seeking number of tracks which is 9000 tracks divided by the predetermined number of photos which is 200. Afterwards, when accessing the same optical disc, the optical disc drive adopts the calibrated track to photo ratio to perform seeking unless the power of the optical disc drive is switched off or the disc is tray out.

Therefore, after the optical disc is placed in the optical disc drive, or when the power of the optical disc drive is switched on and an optical disc is tray in, the procedures of above method is activated. With only one seeking performed in the startup procedure of the optical disc drive, the most optimum track to photo ratio when accessing the disc is obtained.

Besides, the embodiment obtains the optimum track to photo ratio especially when in a long seeking, wherein the long seeking is defined to be over 10,000 tracks. The track pitch error of disc variation in a short seeking is insignificant and harder to identify, while that in a long seeking is more significant, therefore an accurate track to photo ratio can be obtained.

Moreover, in practical application, the invention is more applicable to an optical disc drive adopting a direct current motor to move the pickup module (that is, the sled motor is a direct current motor). Most of the optical disc drives that have photo signals adopt direct current motors. If the optical disc drive adopts a step motor, the method of calculating the number of tracks is different. However, this does not mean that the invention cannot be applied in an optical disc drive adopting a step motor.

Therefore, the advantage of the invention lies in using a fixed long seeking of startup procedure to infer the track to photo ratio that needs to be adjusted. In the subsequent seeking, the optical disc drive can effectively control the precision in seeking without further calibration.

Moreover, another advantage of the invention lies in using the procedures of the method to effectively reduce the required time of seeking and overcome the inefficiency of assessing due to the variation in the manufacturing process of an optical disc.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of improving seeking precision in an optical disc drive, comprising the steps of:
(a) calculating a predetermined number of photos that should be detected by the optical disc drive when moving a pickup module by a predetermined number of tracks;
(b) calculating a actual number of tracks through which the optical disc drive moves when the predetermined number of photos is detected by the optical disc drive, so as to obtain a calibrated track to photo ratio.

2. The method according to claim 1, wherein the predetermined number of tracks is larger than or equal to 10,000.

3. The method according to claim 1, wherein the calibrated track to photo ratio is obtained by having the actual number of tracks divided by the predetermined number of photos.

4. The method according to claim 1, wherein the step (a) is performed only when an optical disc is tray in.

5. The method according to claim 1, wherein step (a) is performed only when the optical disc drive is power on and an optical disc is tray in.

6. A method of improving the seeking precision in an optical disc drive adopting a direct current motor driving a pickup module, comprising the steps of:
(a) driving the direct current motor to move the pickup module until a predetermined number of photos appears;
(b) calculating a actual number of tracks that the pickup module moves when the predetermined number of photos appeas;
(c) obtaining a calibrated track to photo ratio according to the actual number of tracks and the predetermined number of photos.

7. The method according to claim 6, wherein the calibrated track to step ratio is obtained by having the actual number of tracks divided by the predetermined photo number.

8. The method according to claim 7, wherein step (a) is performed only when an optical disc is tray in.

9. The method according to claim 7, wherein step (a) is performed only when the power of optical disc drive is on and an optical disc is tray in.
